(19) United States
(12) Patent Application Publication
(10) Pub. No.: US 2003/0182860 A1
(43) Pub. Date: Oct. 2, 2003

(54) Method and apparatus for providing hydrogen

(76) Inventor: Peter D. DeVries, Tekoa, WA (US)

Correspondence Address: WELLS ST. JOHN P.S., 601 W. FIRST AVENUE, SUITE 1300, SPOKANE, WA, 99201, US

(21) Appl. No.: 10/117,595

(22) Filed: Apr. 1, 2002

(51) Int. Cl. C01B 3/02; C01B 3/24

(52) U.S. Cl. 48/197 R; 423/648.1; 48/197 FM; 48/127.9; 48/61; 48/62 R; 422/188; 422/189; 422/190; 422/198; 422/204; 422/211

(57) ABSTRACT

A method and apparatus for the generation or purification of hydrogen is described, and which includes an enclosure having inner and outer chambers which are substantially separated by a barrier, and which are substantially concentrically aligned; an evaporator coil positioned within the inner chamber for receiving a solution of methanol and water, and wherein the solution of methanol and water is heated to a predetermined temperature; a reformer coil positioned within the inner chamber and coupled in downstream fluid flowing relation relative to the evaporator coil, and which facilitates the decomposition of the heated methanol and water solution into hydrogen gas and other constituents; and a purifier assembly positioned within the inner chamber and coupled in downstream fluid flowing relation relative to the reformer coil, and which substantially separates the hydrogen gas from the other constituents.

### TECHNICAL FIELD

The present invention relates to an apparatus and method for the separation of a constituent gas from a solution or mixture. More specifically, the present invention relates to a method and apparatus for the production and purification of hydrogen from a solution or mixture of alcohol and water.

### BACKGROUND OF THE INVENTION

Hydrogen gas is used as a fuel in a variety of applications. Although hydrogen is abundant in our environment, efficiently and conveniently generating or purifying hydrogen gas so that it may be used as a fuel has proven difficult. Current methods and apparatus used to generate or purify hydrogen have been less than desirable, and often involve large and inefficient devices, wherein much energy is lost as heat. These and other problems are ameliorated by means of the present invention which is described more fully hereinafter.

### SUMMARY OF THE INVENTION

One aspect of the present invention is to provide a method and apparatus for the generation or purification of hydrogen from a solution or mixture of alcohol and water in a more efficient and convenient manner.

Another aspect of the present invention is to provide a method for producing hydrogen, and which includes, providing a solution of an alcohol and water; heating the solution of alcohol and water; providing a reformer coil, and supplying the heated solution of alcohol and water to the reformer coil under conditions which facilitate the decomposition of the alcohol and water solution into hydrogen gas and other constituents; and providing a purifier assembly, and supplying the hydrogen gas and the other constituents to the purifier assembly, wherein the purifier assembly substantially separates the hydrogen gas from the other constituents.

A further aspect of the present invention is to provide a method for producing hydrogen from a solution of methanol and water, and which includes, providing a solution of methanol and water under pressure; providing an evaporator coil which receives the solution; providing a heating assembly for imparting heat energy to the solution received by the evaporator coil, and wherein the solution is heated to a temperature of at least about 270 degrees C. to less than about 300 degrees C.; providing a reformer coil coupled in fluid flowing relation relative to the evaporator coil, and supplying the heated solution to the reformer coil to react and form hydrogen gas and other constituents; and further providing a purifier assembly coupled in fluid flowing relation relative to the reformer coil, and supplying the hydrogen gas and other constituents to the purifier assembly, and wherein the purifier assembly substantially separates the hydrogen gas from the other constituents.

A further aspect of the present invention is to provide an apparatus for producing hydrogen, and which includes, an enclosure having inner and outer chambers which are substantially separated by a barrier, and which are substantially concentrically aligned; an evaporator coil positioned within the inner chamber for receiving a solution of methanol and water, and wherein the solution of methanol and water is heated to a predetermined temperature; a reformer coil positioned within the inner chamber and coupled in downstream fluid flowing relation relative to the evaporator coil, and which facilitates the decomposition of the heated methanol and water solution into hydrogen gas and other constituents; and a purifier assembly positioned within the inner chamber and coupled in downstream fluid flowing relation relative to the reformer coil, and which substantially separates the hydrogen gas from the other constituents.

A further aspect of the present invention is to provide an apparatus for producing hydrogen, and which includes, an enclosure having opposite first and second ends which define, in part, an internal cavity, and wherein the enclosure comprises inner and outer chambers which are substantially separated by a barrier, and wherein the inner and outer chambers are substantially concentrically aligned about a major axis extending between the first and second ends; a burner, electrical resistence heater, or other heat source for providing a heated flue gas to the inner chamber, and wherein the heated flue gas flows in a first direction along the major axis, and from the first end to the second end of the internal cavity; an evaporator coil positioned within the inner chamber for receiving a solution of methanol and water, and which is located in heat receiving relation relative to the heated flue gas; a reformer coil positioned within the inner chamber and coupled in downstream fluid flowing relation relative to the evaporator coil, and which facilitates the decomposition of the methanol and water solution into hydrogen gas and other constituents, and which is located in heat receiving relation relative to the heated flue gas; and a purifier assembly positioned within the inner chamber and coupled in downstream fluid flowing relation relative to the reformer coil, and which substantially separates the hydrogen gas from the other constituents.

### BRIEF DESCRIPTION OF THE DRAWINGS

Preferred embodiments of the invention are described below with reference to the following accompanying drawings.

FIG. 1 is a diagrammatic view of the present invention.

FIG. 2 is a side elevational view of an evaporator and reformer coil assembly utilized with the present invention.

FIG. 3 is a perspective view of an evaporator and reformer coil assembly utilized with the present invention.

FIG. 4 is a fragmentary perspective view of a portion of a reformer coil assembly utilized with the present invention.

FIG. 5 is a perspective view of a case or enclosure assembly utilized with the present invention.

FIG. 6 is a perspective view of the case or enclosure assembly shown in FIG. 5, further showing the evaporator and reformer coil assembly of FIG. 3 positioned within the case or enclosure assembly.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

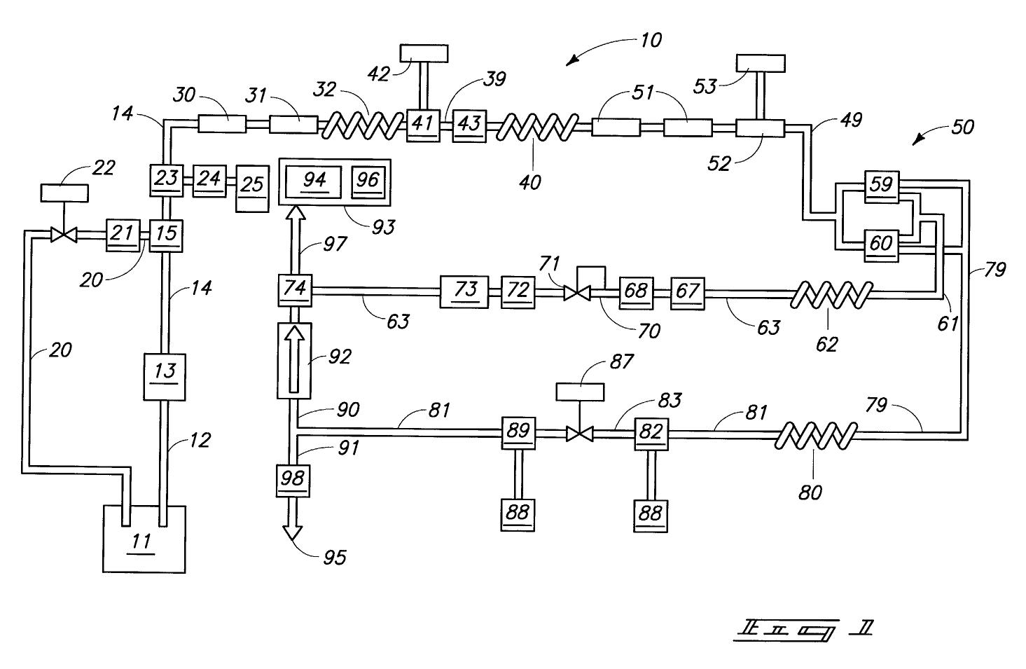

Referring to FIG. 1, a diagrammatic view of a preferred embodiment of the present invention is generally indicated by the numeral 10. As shown, the present invention 10 includes a tank 11 where methanol and water are premixed in a volumetric ratio of approximately two parts methanol to one part water, to give a methanol to water molar ratio of about 0.87 to 0.95. A first conduit 12 couples the tank 11 in fluid flowing relation relative to a highly accurate electronic metering pump 13. A second conduit 14 couples the electronic metering pump 13 in fluid flowing relation relative to an evaporator coil which is described in detail below. The pump 13 withdraws the mixture of methanol and water from the tank 11 through the first conduit 12, and pumps the mixture through the second conduit 14, providing the mixture under pressure of about 150 psig to about 200 psig.

In the depicted embodiment, after the second conduit 14 exits the pump 13, a t-joint 15 serves to couple a bypass bleed line 20 in fluid flowing relation relative to both the tank 11 and to the second conduit 14. The bypass bleed line 20 includes a reducer 21 and a manual needle valve 22. When initially starting the pump 13, the manual needle valve 22 is opened, so that air may be purged from the system. Once the mixture of methanol and water flowing through the first and second conduits 12 and 14 is free of unwanted air bubbles, the manual needle valve 22 is closed, thereby preventing the mixture of methanol and water from flowing through the bypass bleed line 20, and allowing the pump 13 to develop adequate hydraulic pressure. In other embodiments, a solenoid valve may be used in place of the manual needle valve 22, to automatically bleed air from the system.

Still referring to FIG. 1, a t-joint 23 and fitting 24 serve to couple the second conduit 14 in fluid flowing relation relative to a pressure transducer 25. The output pressure of the pump 13 is monitored by the pressure transducer 25. The system pressure is set to deliver the solution of methanol and water to the reformer coil at a pressure in the range of about 150 psig to about 200 psig.

In the depicted preferred embodiment, after leaving the t-joint 23, the second fluid conduit 14 includes a check valve 30 and an adaptor 31. Check valve 30 prevents gases from back-flowing into the needle valve 22 when the pump 13 is turned off. The adaptor 31 serves to couple the second fluid conduit 14 in fluid flowing relation relative to the evaporator coil 32.

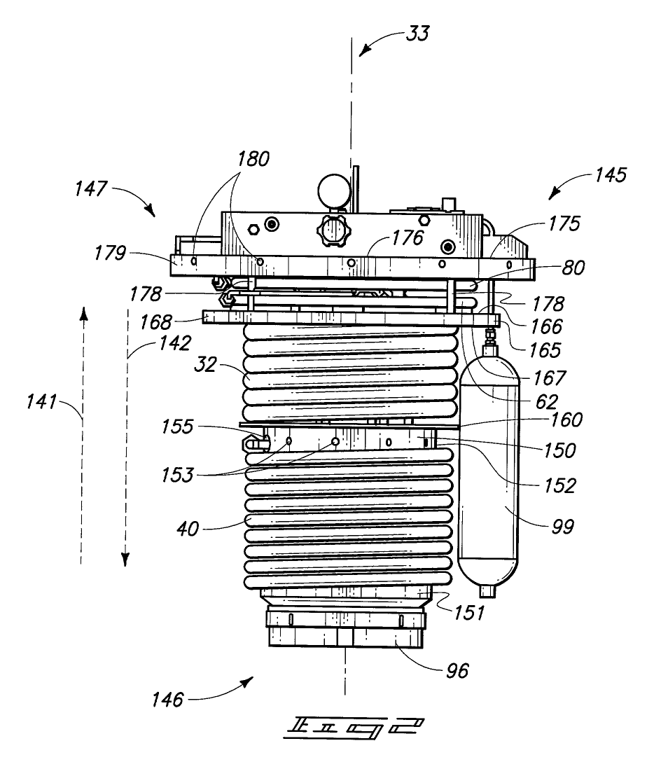

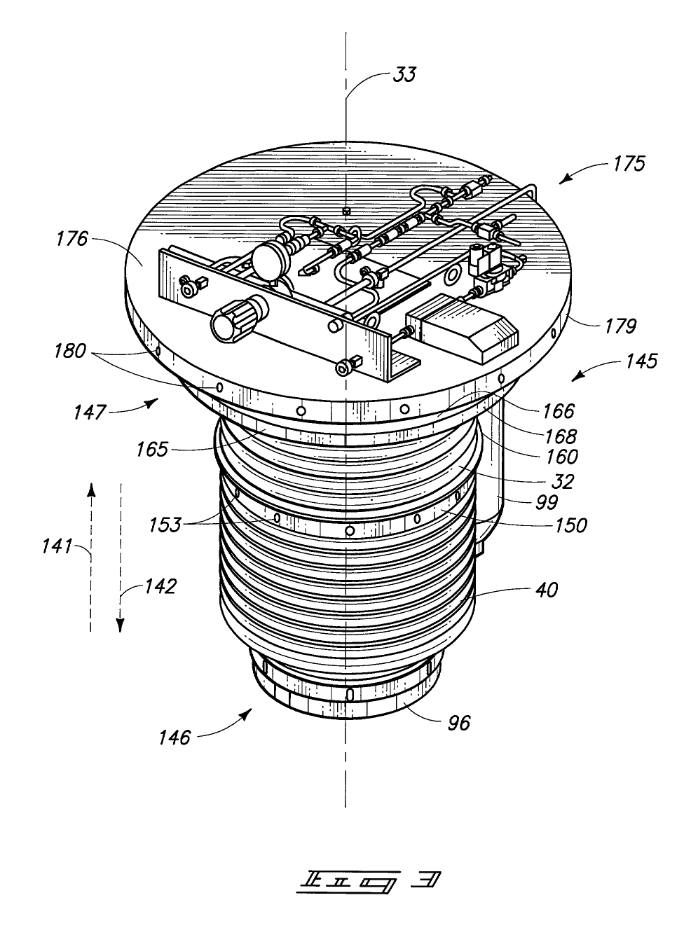

Referring to FIGS. 1-3, the evaporator coil 32 holds the mixture of methanol and water while the mixture is superheated to a temperature of from at least about 250 degrees C. to less than about 300 degrees C. This heating causes the mixture to vaporize. The mixture is preferably heated to a temperature of at least about 270 degrees C. to less than about 300 degrees C. before the mixture is provided to the reformer coil which will be discussed below. As seen best in FIGS. 2 and 3, the evaporator coil 32 includes stainless steel tubing which is substantially concentrically wound about a major axis 33 (shown in phantom lines). Finned stainless steel tubing can be used for increased heat exchange in the event that a shorter length of stainless steel tubing is employed. The heat energy used to heat the mixture of methanol and water within the evaporator coil 32 is provided by a heating assembly which is described in detail below.

Referring again to FIG. 1, a third conduit 39 couples the evaporator coil 32 in fluid flowing relation relative to the reformer coil 40. The third conduit 39 includes a surface-mounted thermocouple 42 to indicate temperature in the third conduit 39. Further, an expander 43 is provided which serves to couple the third conduit 39 to the reformer coil 40.

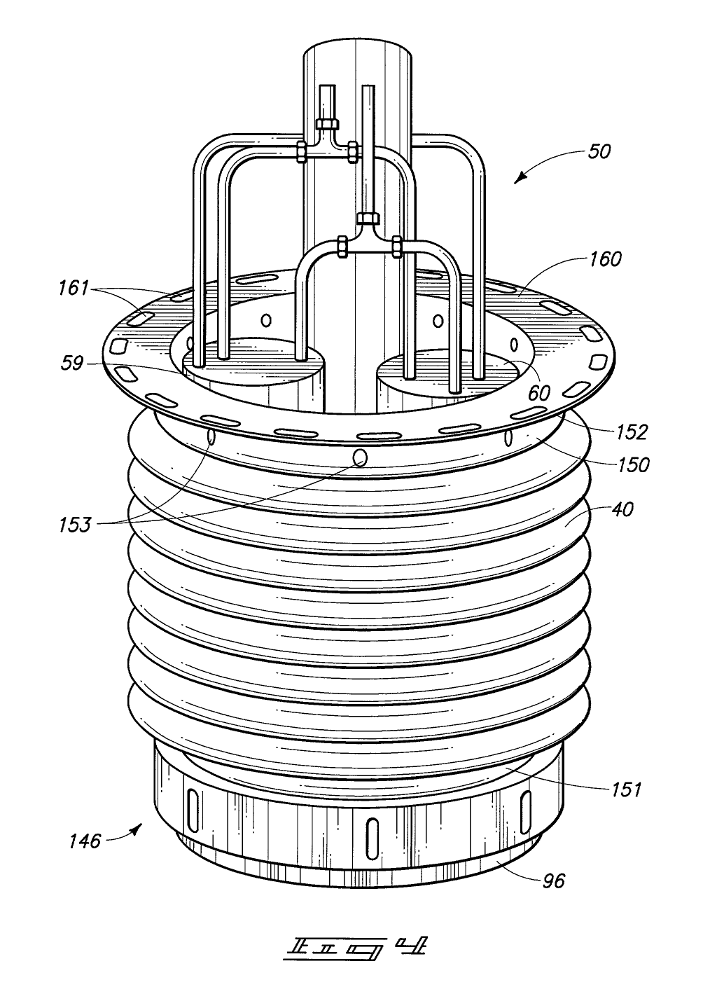

The vaporized and heated mixture of methanol and water is received by the reformer coil 40 under conditions which facilitate the decomposition of the mixture into hydrogen gas and other constituent elements. As best seen in FIGS. 2 and 4, the reformer coil 40 is constructed of stainless steel tubing which is substantially concentrically wound about the major axis 33 (shown in phantom lines). This stainless steel tubing of the reformer coil 40 is packed with approximately 2800 g of a pelletized copper and zinc oxide catalyst (not shown). The vaporized mixture of methanol to water react with the catalyst to produce hydrogen gas and by-products containing carbon dioxide, carbon monoxide, remnant water, and other constituents hereinafter referred to as reformate.

Referring again to FIG. 1, a fourth conduit 49 couples the reformer coil 40 in fluid flowing relation relative to a purifier assembly 50. The fourth fluid conduit 49 includes a pair of reducers 51, and a surface-mounted thermocouple 53 to indicate temperature in the fourth fluid conduit 49.

The hydrogen gas and carbon dioxide produced by the catalyzed chemical reaction in the reformer coil 40 travels through the fourth conduit 49, and is received by the purifier assembly 50. As shown in FIGS. 1 and 4, the purifier assembly 50 includes two purifier cores 59 and 60 which are plumbed in parallel fluid flowing relation such that each of the purifier cores 59 and 60 receive approximately 50% of the reformate entering the purifier assembly 50. As shown in FIG. 1, the fourth conduit 49 bifurcates before reaching the purifier cores 59 and 60.

The purifier cores 59 and 60 may best be see in FIG. 4. Purifier cores 59 and 60 are commercially available palladium membrane units of the type that are typically used in purifier systems designed for semiconductor manufacturing, gas chromatography, and other applications requiring high purity hydrogen. In the depicted embodiment (FIGS. 1 and 4), the purifier cores 59 and 60 were purchased from Power Energy, Inc. When the reformate containing hydrogen and other constituents is presented to the heated palladium membrane within the purifier cores 59 and 60, the hydrogen molecules dissociate into two hydrogen atoms. Each of the hydrogen atoms loses its electron to the palladium alloy membrane and diffuses through the metal lattice as a proton. After the protons pass through the metal lattice, the electrons recombine with the protons to once again form hydrogen molecules. Since the palladium alloy membrane is a selective filter for hydrogen, the hydrogen gas produced can achieve purity levels as high as 99.9999999%.

Referring to FIGS. 1 and 3, waste gas or raffinate, containing unrecovered hydrogen, and other constituents or contaminants such as carbon dioxide, water and reaction intermediates exit the purifier cores 59 and 60 and travel through a fifth conduit 61 (FIG. 1). The fifth conduit 61 couples purifier cores 59 and 60 in fluid flowing relation relative to the raffinate cooling coil 62 (FIG. 2), so that the waste gas and other constituents or contaminants (i.e. carbon dioxide, water and reaction intermediates) may flow to the raffinate cooling coil 62 for cooling. A sixth conduit 63 couples the raffinate cooling coil 62 in fluid flowing relation relative to a heating assembly which is described below. The sixth conduit 63 includes an expander 67, and a back pressure valve 71. The sixth conduit 63 also includes a reducer 73 and a t-joint 74.

Referring again to FIG. 1, the seventh conduit 79 couples purifier cores 59 and 60 in fluid flowing relation relative to a reformate cooling coil 80, so that purified reformate (i.e. purified hydrogen gas) may flow to the purified hydrogen cooling coil 80 for cooling. An eighth conduit 81 couples the purified hydrogen cooling coil 80 in fluid flowing relation relative to a fluid output, which is described below. The eighth conduit 81 includes a t-joint 82 to couple conduit 81 to a pressure transducer 88. A ninth conduit 83 includes a back-pressure regulator 87, and a t-joint 89 to couple conduit 83 to pressure transducer 88. From t-joint 89, the eighth conduit 81 bifurcates to form second and third purified hydrogen branches 90 and 91. The third purified hydrogen branch 90 includes a check valve 92, and which is coupled in fluid controlling relation relative to a t-joint 74. As shown in FIG. 1, heater conduit 97 is coupled in fluid flowing relation to receive both raffinate from the sixth conduit 63, and purified hydrogen from the eighth conduit 81, so that both may be delivered to the heating assembly 93 as described below. The fourth purified hydrogen branch 91 is coupled in fluid flowing relation relative to the fluid output 95. The fourth purified hydrogen branch 91 also includes a solenoid valve 98 which is coupled in fluid flowing relation relative to the purified hydrogen cooling coil 80. The solenoid valve 98 receives the cooled hydrogen gas from the purified hydrogen cooling coil 80, and controls the final flow of the cooled hydrogen gas that is released from the reformer 10. In the embodiment, as shown, the purified hydrogen is delivered to an accumulator 99 (FIGS. 2-3 and 6). The cooled purified hydrogen may also be directly delivered to a fuel cell or other apparatus.

Referring again to FIG. 1 in the embodiment, as shown, the heating assembly 93 includes a burner 96 for imparting heat energy. The burner 96 is preferably a catalytic burner. In this regard, the hydrogen gas and/or by-products which have been produced during the reforming process are supplied in part, to the burner 96 as a fuel to be combusted and consumed therein. The combustion of the fuel and other constituents or contaminants produces a heated flue gas. In other embodiments, rather than being supplied to the burner 96, all or at least some of the waste gas (i.e. raffinate) is vented from the reformer 10. A more detailed description of the heating assembly is provided below.

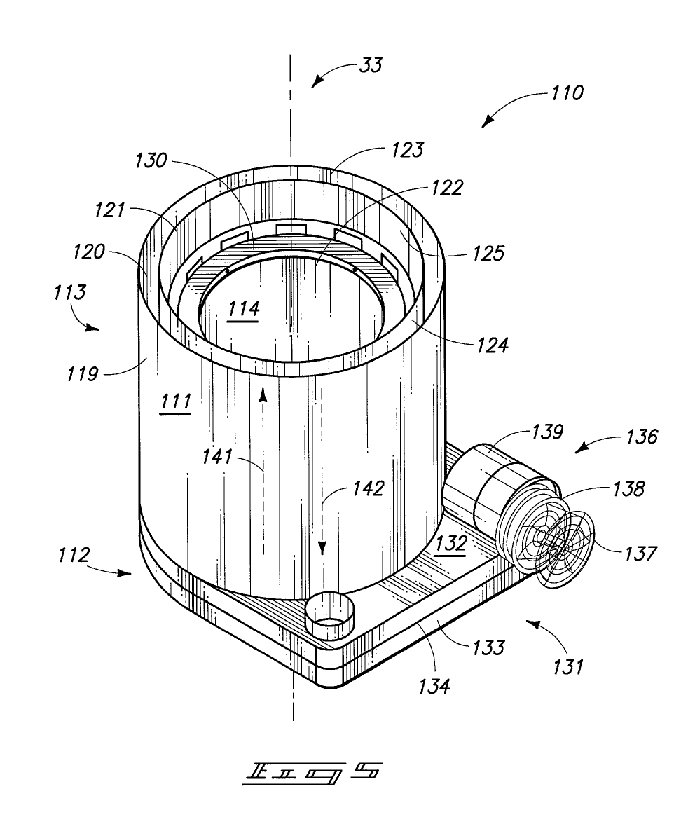

Referring again to FIGS. 1, 5 and 6, much of the apparatus 10 is housed in an enclosure 110. The enclosure 110 has an outer cylindrical wall 111, and opposite first and second ends 112 and 113, which define in part an internal cavity 114. The outer cylindrical wall 111 has an outer surface 119 and an inner surface 120. A cylindrical barrier 121 is received within the internal cavity 114, and is substantially concentrically aligned and disposed in spaced relation relative to the outer cylindrical wall 111 of the enclosure 110. The cylindrical barrier 121 divides the internal cavity into inner and outer chambers 122 and 123. As shown, the outer chamber 123 defines, in part, a tubular or annular void which is defined between the outer cylindrically shaped wall 111 of the enclosure 110, and the cylindrically shaped barrier 121. The outer chamber 123 also includes that portion of the internal cavity 114 located within the outer cylindrically shaped wall at the first end 112 of the internal cavity 114 above the cylindrically shaped barrier 121. The inner chamber 122 defines a substantially cylindrically shaped void. The cylindrically shaped barrier 121 has an outer surface 124 and an inner surface 125. A divider ring 130 is attached to the inner surface 125 of the cylindrically shaped barrier 121 as shown in FIG. 5.

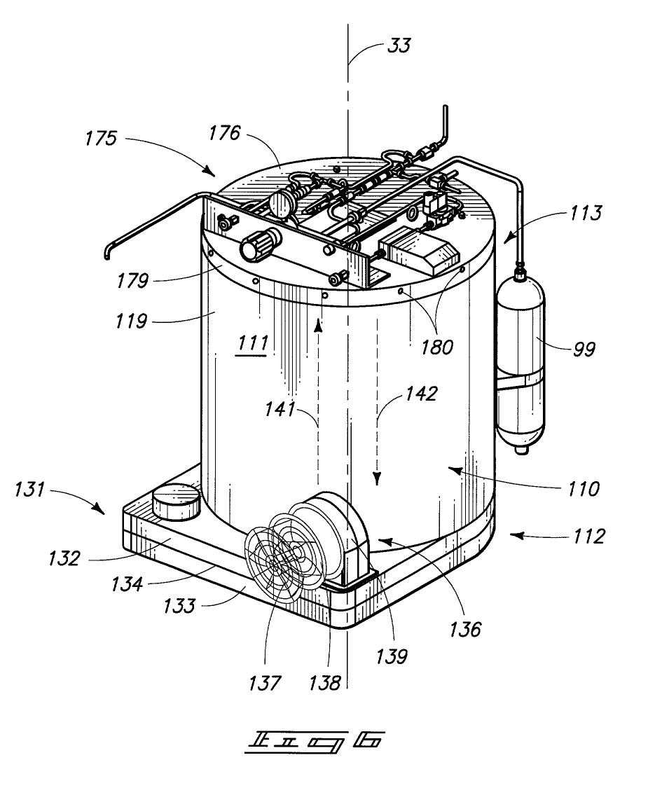

Referring now to FIGS. 5 and 6, the outer cylindrically shaped wall 111 is affixed to a base 131. The base 131 includes an upper plenum cover 132 and a lower plenum pan 133. The upper plenum cover 132 and the lower plenum pan 133 are substantially sealed at a seam 134. A void or air plenum (not shown) extends between and is defined by the upper plenum cover 132 and the lower plenum pan 133.

As shown in FIGS. 5 and 6, a fan is provided. The fan 136 includes a fan guard 137 which covers the fan blade assembly 138. The fan guard 137 and fan blade assembly 138 are attached to the fan housing 139. The fan housing 139 is mounted to the upper plenum cover 132, and is disposed in an orientation which facilitates the flow of air from ambient into the air plenum. After flowing through the air plenum, the air flow is directed in a manner such that it flows upward through the outer chamber 123 and in a first direction 141 (shown in phantom lines). After flowing through the outer chamber 123, the air is directed in a generally downward direction through the inner chamber 122 as seen in the phantom lines labeled 142. This air pathway flows into the catalytic burner 96 for subsequent combustion.

Referring now to FIGS. 2 and 3, a coil assembly is generally indicated by the numeral 145. As shown in FIG. 3, the coil assembly 145 has a first end 146 and a second end 147. When the apparatus 10 is fully assembled, the coil assembly 145 is substantially received within the enclosure 110. In the following paragraphs, the positional and functional relationships of the coil assembly 145 and the enclosure 110 are further described.

Referring still to FIGS. 2 and 3, the catalytic burner 96 is located near the first end 146 of the coil assembly 145. A cylindrical burner shroud 150 (FIG. 2) encircles the burner 96, and extends substantially upwardly. The cylindrical burner shroud 150 includes a base end 151 and an opposite, upper end 152. The cylindrical burner shroud 150 is substantially concentrically aligned relative to the major axis 33. The cylindrically shaped burner shroud 150 includes several small apertures 153 (FIG. 3) each of which penetrate the cylindrical burner shroud 150, and which provides passageways through which gases may flow. The cylindrical burner shroud 150 also includes a base reformer aperture (not shown) through which the reformer coil 40 passes before coupling in fluid flowing relation relative to the purifier assembly 50. Further, an upper reformer aperture 155 (FIG. 2) is provided and through which the reformer coil 40 couples in fluid flowing relation relative to the evaporator coil 32. A burner shroud ring 160 is securely affixed to the upper end 152 of the cylindrical burner shroud 150. The burner shroud ring 160 includes several ring apertures 161 (FIG. 4) which penetrate the burner shroud ring 160.

The evaporator coil 32 is positioned elevationally above the burner shroud ring 160. The evaporator coil 32 receives the solution of methanol and water while the solution is heated to a predetermined temperature. As seen best in FIGS. 2 and 3, the evaporator coil 32 comprises a stainless steel tube which is substantially concentrically wound about the major axis 33. The evaporator coil 32 is disposed in heat receiving relation relative to the heated flue gas which is produced by the burner 96. An inner chamber cap 165 (FIG. 3) is located over the evaporator coil 32. The inner chamber cap 165 has an upper surface 166 and a lower surface 167 (FIG. 2). A cylindrical lip 168 extends circumferentially, downwardly from the edge of the inner chamber cap 165.

Referring now to FIGS. 2, 3 and 6, a coil assembly cap 175 is located over the inner chamber cap 165 as shown. The coil assembly cap 175 has an upper surface 176 and a lower surface (not shown). Several substantially vertically oriented braces 178 are secured to the upper surface 166 of the inner chamber cap 165, and extend normally upwardly therefrom. A cylindrically shaped lip 179 extends circumferentially downwardly from the coil assembly cap 175. Several fastener receiving apertures 180 extend through the cylindrically shaped lip 179.

Referring now to FIGS. 1, 2 and 3, the reformer coil 40 is coupled in downstream, fluid flowing relation relative to the evaporator coil 32. The reformer coil 40 is disposed in heat receiving relation relative to the heated flue gas which is produced by the burner 96. As described above, the reformer coil 40 facilitates the decomposition of the heated methanol and water solution into hydrogen gas and other constituents. As best seen in FIGS. 2 and 4, the reformer coil 40 is constructed of a stainless steel tube which is substantially concentrically wound about the major axis 33. The stainless steel tube is packed with a pelletized copper and zinc oxide catalyst (not shown). The vaporized mixture of methanol and water react with the catalyst to produce hydrogen gas, carbon dioxide and other by-products.

As best understood by a study of FIGS. 1 and 4, the purifier assembly 50 is coupled in downstream fluid flowing relation relative to the reformer coil 40. The hydrogen gas and carbon dioxide generated by the reformer coil 40 flows through fourth conduit 49, and into the purifier assembly 50. As shown in FIGS. 1 and 4, the purifier assembly 50 includes two purifier cores 59 and 60 which are fluid-flowingly coupled in parallel relation, so that each of the purifier cores 59 and 60 will receive approximately 50% of the hydrogen gas and carbon dioxide which enter the purifier assembly 50.

Referring again to FIG. 1, the fifth conduit 61 couples the respective purifier cores 59 and 60 in fluid flowing relation relative to the raffinate cooling coil 62. The seventh conduit 79 which is provided couples the respective purifier cores 59 and 60 in fluid flowing relation relative to the purified hydrogen cooling coil 80. The purified hydrogen cooling coil 80 operates to receive and cool the hydrogen gas which has been substantially separated from the other constituents or contaminants. Both the raffinate cooling coil 62 and the purified hydrogen cooling coil 80 are positioned over the inner chamber cap 165 and below the coil assembly cap 175. As shown best in FIGS. 1 and 2, the cooling coils 62 and 80 are each constructed of a stainless steel tube which is substantially concentrically wound about the major axis 33.

When the apparatus 10 is assembled, the first end 146 of the coil assembly 145 (FIGS. 2 and 3) is inserted into the inner chamber 122 of the enclosure 110 (FIG. 5). Further, the coil assembly 145 (FIG. 2) is positioned within the enclosure 110 so that the upper edge of the outer cylindrically shaped wall 111 is received in apposition to the lower surface of the coil assembly cap 175. Therefore, the coil assembly cap 175 substantially covers the opening at the second end 113 of the enclosure 110. Similarly, the upper edge of the cylindrically shaped barrier 121 is received in substantial apposition to the lower surface 167 of the inner chamber cap 165. This arrangement substantially separates the inner chamber 122 from the outer chamber 123.

Referring now to FIG. 6, when the apparatus 10 has been fully assembled, the only portions of the coil assembly 145 which are visible from the exterior of the apparatus 10 are the coil assembly cap 175 and associated structures positioned over the coil assembly cap 175. Fasteners such as bolts or screws, may be threadably received in the fastener receiving apertures 180 of the cylindrical lip 179, and threadably advanced against the outer surface 119 of the outer wall 111 to releasably secure the coil assembly 145 within the internal cavity 114.

Therefore, when the apparatus 10 has been fully assembled, the first end 146 of the coil assembly 145 is positioned near the first end 112 of the enclosure 110, while the second end 147 of the coil assembly 145 is positioned near the second end 113 of the enclosure 110. The evaporator and reformer coils 32 and 40 are each positioned within the inner chamber 114, with the evaporator coil 32 being positioned elevationally above the reformer coil 40. Both the raffinate cooling coil 62, and the purified hydrogen cooling coil 80 are positioned within the outer chamber 123, and in a position over the inner chamber cap 165 and below the coil assembly cap 175.

Referring now to FIG. 1, the details of the heating assembly 93 are now described in further detail. As should be understood, the heating assembly 93 imparts heat energy to the solution of methanol and water, and maintains the reformer coil 40 and purifier assembly 50 at appropriate operational temperatures. The heating assembly 93 (FIG. 1) includes a supplemental heater 94 for imparting heat energy to the solution of methanol and water until a predetermined operating temperature is reached. In the present embodiment, this supplemental heater 94 is an electric heater. However, in other embodiments, the supplemental heat may be provided by a propane burner or other assembly. In one possible embodiment, the predetermined operating temperature is reached when the reformer 10 is thermally self-supporting. This would occur when the burner 96 is producing sufficient heat energy for the reformer to operate without the need for supplemental heat.

The flow of the flue gas produced by the heating assembly 93 is now described with reference to the drawings. As described above, the heating assembly 93 includes a catalytic burner 96 for imparting heat energy. In one form of the invention, a portion of the hydrogen gas and/or by-products which have been produced during the reforming process are supplied to the burner 96 as a fuel to be combusted therein. The combustion of the fuel produces a heated flue gas which is exhausted into the inner chamber 122. Once received, the heated flue gas flows in a first direction 141 (shown by phantom lines in FIGS. 2, 3 and 5) and along the major axis 33. As the heated flue gas flows through the inner chamber 122, it flows past the reformer coil 40 thereby imparting heat energy to same. After the heated flue gas has moved past the reformer coil 40, the heated flue gas flows past the evaporator coil 32, where the heated flue gas imparts further heat energy to the solution of alcohol and water within the evaporator coil 32. This heat energy causes the solution to increase to a temperature of at least about 270 degrees C. to less than about 300 degrees C.

As best seen in FIGS. 5-6, the fan 136 is mounted to the upper plenum cover 132 and facilitates the flow of air from ambient into the air plenum (not shown). After flowing through the air plenum, the ambient air is directed to flow upwardly through the outer chamber 123 and in a first direction 141 (shown in phantom lines). After flowing through the outer chamber 123, the air is directed to flow downwardly through the inner chamber 122 in a second direction 142 (shown in phantom lines), and into the catalytic burner 96 for combustion therein.

### OPERATION OF THE PREFERRED EMBODIMENTS

The operation of the described embodiment of the present invention is believed to be readily apparent and is briefly summarized at this point. In its broadest aspect, the present invention relates to a method for producing hydrogen, which includes, providing a solution of an alcohol and water; heating the solution of alcohol and water; providing a reformer coil 40, and supplying the heated solution of alcohol and water to the reformer coil 40 under conditions which facilitate the decomposition of the alcohol and water solution into hydrogen gas and other constituents; and providing a purifier assembly 50, and supplying the hydrogen gas and the other constituents to the purifier assembly 50, and wherein the purifier assembly 50 substantially separates the hydrogen gas from the other constituents.

As disclosed above, in the present invention the alcohol is methanol, and the solution of methanol and water is mixed in a volumetric ratio of approximately two parts methanol to one part water. Still further, the step of providing a solution of an alcohol and water includes providing at least one pump 13 which provides the solution of alcohol and water under a pressure of about 150 psi to about 200 psi. Further, the step of heating the solution of alcohol and water includes heating the solution of alcohol and water to a temperature of at least about 270 degrees C. to less than about 300 degrees C. before providing the solution of alcohol and water to the reformer coil 40.

As disclosed above, the step of heating the solution of alcohol and water includes providing a supplemental heater 94 for imparting heat energy to the solution of alcohol and water until a predetermined operating temperature is reached. Yet further, the disclosed invention includes a step of providing a burner 96 for imparting heat energy to the solution of alcohol and water; and supplying at least a portion of the hydrogen and other constituents from the purifier assembly 50 to the burner 96 as a fuel to be combusted therein. As earlier discussed, the combustion of the fuel (hydrogen) and other by products produces a heated flue gas. Still further the method includes providing an evaporator coil 32 coupled in upstream fluid flowing relation relative to the reformer coil 40, and which receives the solution of alcohol and water; and directing the heated flue gas to flow past the evaporator coil 32. As discussed earlier, the heated flue gas imparts heat energy to the solution of alcohol and water received by the evaporator coil 32.

As disclosed above, the method includes the steps of providing a solution of methanol and water under pressure; providing an evaporator coil 32 which receives the solution; providing a heating assembly 93 for imparting heat energy to the solution received by the evaporator coil 32, and wherein the solution is heated to a temperature of at least about 270 degrees C. to less than about 300 degrees C.; providing a reformer coil 40 coupled in fluid flowing relation relative to the evaporator coil 32, and supplying the heated solution to the reformer coil 40 to react and form hydrogen gas and other constituents; and providing a purifier assembly 50 coupled in fluid flowing relation relative to the reformer coil 40, and supplying the hydrogen gas and other constituents to the purifier assembly 50, and wherein the purifier assembly 50 substantially separates the hydrogen gas from the other constituents.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A method for producing hydrogen, comprising:
providing a solution of an alcohol and water;
heating the solution of alcohol and water;
providing a reformer coil, and supplying the heated solution of alcohol and water to the reformer coil under conditions which facilitate the decomposition of the alcohol and water solution into hydrogen gas and other constituents; and
providing a purifier assembly, and supplying the hydrogen gas and the other constituents to the purifier assembly, wherein the purifier assembly substantially separates the hydrogen gas from the other constituents.

2. A method as claimed in claim 1, wherein the alcohol is methanol, and wherein the solution of methanol and water is mixed in a volumetric ratio of approximately two parts methanol to one part water.

3. A method as claimed in claim 1, wherein the step of providing a solution of an alcohol and water further comprises:
providing at least one pump which provides the solution of alcohol and water under a pressure of about 150 psi to about 200 psi.

4. A method as claimed in claim 1, wherein the step of heating the solution of alcohol and water further comprises:
heating the solution of alcohol and water to a temperature of at least about 270 degrees C. to less than about 300 degrees C. before providing the solution of alcohol and water to the reformer coil.

5. A method as claimed in claim 1, wherein the step of heating the solution of alcohol and water further comprises:
providing a supplemental heater for imparting heat energy to the solution of alcohol and water until a predetermined operating temperature is reached.

6. A method as claimed in claim 1, wherein the step of heating the solution of alcohol and water further comprises:
providing a burner for imparting heat energy to the solution of alcohol and water; and
supplying at least a portion of the other constituents from the purifier assembly to the burner as a fuel to be combusted therein, and wherein combustion of the fuel produces a heated flue gas.

7. A method as claimed in claim 1, wherein the step of heating the solution of alcohol and water further comprises:
providing a burner for imparting heat energy to the solution of alcohol and water; and
supplying at least a portion of the hydrogen gas from the purifier assembly to the burner as a fuel to be combusted therein, and wherein combustion of the fuel produces a heated flue gas.

8. A method as claimed in claim 1, wherein the step of heating the solution of alcohol and water further comprises:
providing a burner for imparting heat energy to the solution of alcohol and water; and
supplying at least a portion of the other constituents from the purifier assembly and at least a portion of the hydrogen gas from the purifier assembly to the burner as a fuel to be combusted therein, and wherein combustion of the fuel produces a heated flue gas.

9. A method as claimed in claim 8, wherein the step of heating the solution of alcohol and water further comprises:
providing an evaporator coil coupled in upstream fluid flowing relation relative to the reformer coil, and which receives the solution of alcohol and water; and
directing the heated flue gas to flow past the evaporator coil, wherein the heated flue gas imparts heat energy to the solution of alcohol and water received by the evaporator coil, and wherein the solution of alcohol and water is heated to a temperature of at least about 270 degrees C. to less than about 300 degrees C.

10. A method for producing hydrogen from a solution of methanol and water, comprising:
providing a solution of methanol and water under pressure;
providing an evaporator coil which receives the solution;
providing a heating assembly for imparting heat energy to the solution received by the evaporator coil, and wherein the solution is heated to a temperature of at least about 270 degrees C. to less than about 300 degrees C;
providing a reformer coil coupled in fluid flowing relation relative to the evaporator coil, and supplying the heated solution to the reformer coil to react and form hydrogen gas and other constituents; and
providing a purifier assembly coupled in fluid flowing relation relative to the reformer coil, and supplying the hydrogen gas and other constituents to the purifier assembly, and wherein the purifier assembly substantially separates the hydrogen gas from the other constituents.

11. A method as claimed in claim 10, wherein the step of providing a solution of methanol and water under pressure further comprises:
providing the solution of methanol and water mixed in a volumetric ratio of approximately two parts methanol to one part water; and
providing at least one pump which provides the solution of methanol and water under a pressure of about 150 psi to about 200 psi.

12. A method as claimed in claim 10, wherein the step of providing a heating assembly further comprises:
providing a supplemental heater for imparting heat energy to the solution of methanol and water until a predetermined operating temperature is reached.

13. A method as claimed in claim 10, wherein the step of providing a heating assembly further comprises:
providing a burner, and supplying the other constituents from the purifier assembly to the burner as a fuel to be combusted therein, and wherein combustion of the fuel produces a heated flue gas.

14. A method as claimed in claim 10, wherein the step of providing a heating assembly further comprises:
providing a burner, and supplying at least a portion of the hydrogen gas from the purifier assembly to the burner as a fuel to be combusted therein, and wherein combustion of the fuel produces a heated flue gas.

15. A method as claimed in claim 10, wherein the step of providing a heating assembly further comprises:
providing a burner, and supplying at least a portion of the other constituents from the purifier assembly and at least a portion of the hydrogen gas from the purifier assembly to the burner as a fuel to be combusted therein, and wherein combustion of the fuel produces a heated flue gas.

16. A method as claimed in claim 10, wherein step of providing a heating assembly further comprises:
providing a burner, and supplying at least a portion of the other constituents from the purifier assembly to the burner as a fuel to be combusted, and wherein combustion of the fuel produces a heated flue gas;
directing the heated flue gas to flow past the reformer coil to impart heat energy thereto; and
after the heated flue gas has moved past the reformer coil, directing the heated flue gas to flow past the evaporator coil to impart heat energy thereto.

17. An apparatus for producing hydrogen, comprising:
an enclosure having inner and outer chambers which are substantially separated by a barrier, and which are substantially concentrically aligned;
an evaporator coil positioned within the inner chamber for receiving a solution of methanol and water, and wherein the solution of methanol and water is heated to a predetermined temperature;
a reformer coil positioned within the inner chamber and coupled in downstream fluid flowing relation relative to the evaporator coil, and which facilitates the decomposition of the heated methanol and water solution into hydrogen gas and other constituents; and
a purifier assembly positioned within the inner chamber and coupled in downstream fluid flowing relation relative to the reformer coil, and which substantially separates the hydrogen gas from the other constituents.

18. An apparatus as claimed in claim 17, and further comprising:
a heating assembly for imparting heat energy to the solution of methanol and water.

19. An apparatus as claimed in claim 18, wherein the heating assembly further comprises:
a burner which receives at least a portion of the other constituents from the purifier assembly as a fuel to be combusted therein, and wherein the combustion of the fuel produces a heated flue gas which is exhausted into the inner chamber.

20. An apparatus as claimed in claim 17, and further comprising:
a cooling coil positioned within the outer chamber, and coupled in downstream fluid flowing relation relative to the purifier assembly, and which receives the hydrogen gas which has been substantially separated from the other constituents by the purifier assembly, and which facilitates the dissipation of heat energy from the hydrogen gas as it flows through the cooling coil.

21. An apparatus as claimed in claim 17, and further comprising:
a catalytic burner which receives at least a portion of the other constituents from the purifier assembly as a fuel to be combusted therein, and wherein the combustion of the fuel produces a heated flue gas which is exhausted into the inner chamber.

22. An apparatus as claimed in claim 21, and further comprising:
at least one fan which facilitates a flow of air from ambient into the outer chamber, through the inner chamber, and to the burner for combustion therein.

23. An apparatus as claimed in claim 22, wherein the heated flue gas flows through the inner chamber in substantially a first direction, and wherein the air from ambient flows through the inner chamber in substantially a second direction, and wherein the first and second directions are substantially opposite directions.

24. An apparatus for producing hydrogen, comprising:
an enclosure having opposite first and second ends which define in part an internal cavity, and wherein the enclosure comprises inner and outer chambers which are substantially separated by a barrier, and wherein the inner and outer chambers are substantially concentrically aligned about a major axis extending between the first and second ends;
a burner for providing a heated flue gas to the inner chamber, and wherein the heated flue gas flows in a first direction along the major axis, from the first end to the second end of the internal cavity;
an evaporator coil positioned within the inner chamber for receiving a solution of methanol and water, and which is located in heat receiving relation relative to the heated flue gas;
a reformer coil positioned within the inner chamber and coupled in downstream fluid flowing relation relative to the evaporator coil, and which facilitates the decomposition of the methanol and water solution into hydrogen gas and other constituents, and which is located in heat receiving relation relative to the heated flue gas; and
a purifier assembly positioned within the inner chamber and coupled in downstream fluid flowing relation relative to the reformer coil, and which substantially separates the hydrogen gas from the other constituents.

25. An apparatus as claimed in claim 24, wherein at least a portion of the reformer coil is substantially concentrically wound about the major axis.

26. An apparatus as claimed in claim 24, wherein at least a portion of the evaporator coil is substantially concentrically wound about the major axis.

27. An apparatus as claimed in claim 24, wherein at least a portion of both the evaporator and reformer coils are substantially concentrically wound about the major axis.

28. An apparatus as claimed in claim 27, and further comprising a purified hydrogen cooling coil located within the outer chamber for receiving and cooling the hydrogen gas which has been substantially separated from the other constituents, and wherein at least a portion of the purified hydrogen cooling coil is substantially concentrically wound about the major axis.

29. An apparatus as claimed in claim 28, wherein the reformer coil is positioned proximate the first end to the enclosure, and wherein the purified hydrogen cooling coil is positioned proximate the second end of the enclosure, and wherein the evaporator coil is positioned between the reformer and purified hydrogen cooling coils.

30. An apparatus as claimed in claim 29, and further comprising:
a regulator coupled in fluid flowing relation relative to the purified hydrogen cooling coil, and which receives the cooled hydrogen gas from the purified hydrogen cooling coil, and which regulates a final pressure of the cooled hydrogen gas.

31. An apparatus as claimed in claim 24, wherein at least a portion of the reformer coil is substantially concentrically wound about the major axis, and wherein at least a portion of the reformer coil is packed with pelletized copper zinc oxide catalyst.

32. An apparatus as claimed in claim 24, wherein the solution of methanol and water received by the evaporator coil is mixed in a volumetric ratio of approximately two parts methanol to one part water, and wherein the solution of methanol and water received by the evaporator coil is heated to a temperature of at least about 270 degrees C. to less than about 300 degrees C.

33. An apparatus as claimed in claim 24, and further comprising:
at least one fan which facilitates a flow of air from ambient into the outer chamber, through the inner chamber, and to the burner for combustion therein.

34. An apparatus as claimed in claim 33, wherein the heated flue gas flows through the inner chamber in a first direction, and wherein the air from ambient flows through the inner chamber in a second direction, and wherein the first and second directions are substantially opposed.

35. An apparatus as claimed in claim 24, wherein the purifier assembly comprises a plurality of palladium membrane purifier cores, and wherein the palladium membrane purifier cores are in parallel, fluid flowing relation and wherein each purifier cores receives a substantially equal flow of hydrogen gas and other constituents from the reformer coil.

36. An apparatus as claimed in claim 24, wherein the reformer coil is positioned proximate the first end of the enclosure, and wherein the evaporator coil is positioned proximate the second end of the enclosure.
